(19) United States
(12) Patent Application Publication
(10) Pub. No.: US 2006/0140358 A1
(43) Pub. Date: Jun. 29, 2006

(54) Call handling method and apparatuses

(76) Inventor: David Grubb, Doylestown, PA (US)

Correspondence Address: MAYER & WILLIAMS PC, 251 NORTH AVENUE WEST, 2ND FLOOR, WESTFIELD, NJ, 07090, US

(21) Appl. No.: 11/025,025

(22) Filed: Dec. 29, 2004

(51) Int. Cl. H04M 1/64

(52) U.S. Cl. 379/88.17

(57) ABSTRACT

A call handling apparatus includes a recording medium (34) operative to store a call record (38) associated with a call made by a calling party (16) to a called party (17) and received by a plain-old-telephone service (“POTS”) telecommunication interface (19) disposed at an end-user site (14) associated with the called party (17). A web server (20) is configured for use at the end-user site (14) to receive the call record.(38) from the recording medium, and to generate a World Wide Web (“Web”) page (72) based on the call record. The call record (38) is remotely accessible by the called party (17) using a Web browser (94) configured to access the Web page (72).

### BACKGROUND

Aspects of this invention relate generally to telecommunications, and more particularly to a method and apparatuses for handling calls at a site associated with an end-user of a voice messaging system.

Voicemail systems that are integrated with telecommunication services—both traditional services provided over circuit-switched networks such as the public switched telephone network (“PSTN”), and newer services provided over packet-switched networks such as the Internet—have largely replaced traditional in-home/in-business answering machines, at least in part because end-users enjoy the variety of options for sending and receiving messages that such network-based voicemail systems supply.

Voicemail systems provisioned by voice-over-Internet Protocol (“VoIP”) telecommunication service providers such as Vonage, for example, may allow subscribers with VoIP-enabled telephone systems to access voicemail accounts through a website supplied by the VoIP service providers. Voicemail systems provided with PSTN telecommunication services, such as systems for use by subscribers that have plain-old-telephone service (POTS), are also provisioned by service providers, and have not heretofore supplied voicemail access via websites.

POTS users, therefore, have needs for handling calls, such as voice messaging apparatuses and methods, that are co-located with, and controlled by, the POTS users, and which include features typically available only to users of VoIP telecommunication services and/or telephone systems.

### SUMMARY

According to an aspect of the present invention, a call handling apparatus includes a recording medium operative to store a call record associated with a call made by a calling party to a called party and received by a plain-old-telephone service (“POTS”) telecommunication interface disposed at an end-user site (such as a home) associated with the called party; and a web server (such as a home gateway or a personal computer) configured for use at the end-user site to receive the call record from the recording medium and to generate a World Wide Web (“Web”) page based on the call record. The call record is remotely accessible by the called party using a Web browser configured to access the Web page.

The Web page is operable to remotely control the call handling apparatus. The call record may include one or more call characteristics, such as the time the call was received, the calling party's phone number, whether the call was answered, whether an audio message was left, and the duration of the call. A coder-decoder (“CODEC”), which is operative to receive audio messages from both the calling party and from end-users of the call handling apparatus, may also be included in the call handling apparatus, and may use an encoding tool (such as an MP3 algorithm) to form encoded audio messages (such as MP3 files), which are stored in the recording medium. The web server may be configured include the encoded audio messages on the Web page, where they are remotely accessible using the Web browser.

According to another aspect of the present invention, a method for call handling includes: at an end-user site associated with a called party, arranging for storage of a call record associated with a call made by a calling party to the called party and received by a POTS telecommunication interface disposed at the end-user site; and at the end-user site, arranging for generating a Web page based on the call record, the call record remotely accessible by the called party using a Web browser configured to access the Web page.

In addition, the method may include arranging, at the end-user site, for storage of an audio message, which may be either a calling party audio message received from the telecommunications interface and associated with the call, or an end-user audio message received from an end-user communication interface disposed at the end-user site. The audio message may be encoded using an encoding tool, to form an encoded audio message, which may be included in the Web page and remotely accessed using the Web browser. The audio message may also be appended to an email and transmitted to an email address. A calling party may receive a number of notification options via the POTS telecommunication interface, such as methods for notifying the called party of the call (for example, emailing, short-message-service, paging, or call forwarding). The call record may be forwarded to the called party via the selected notification method.

In accordance with a further aspect of the present invention, a computer-readable medium is encoded with a computer program which, when loaded into a processor, implements the foregoing method.

In accordance with a still further aspect of the present invention, a call handling apparatus includes: a computer-readable storage medium configured to store a computer program; and a processor responsive to the computer-readable storage medium and to the computer program. When loaded into the processor and executed, the computer program is operative to: arrange for storage of a call record associated with a call made by a calling party to a called party and received by a POTS telecommunication interface disposed at an end-user site associated with the called party; and at the end-user site, arrange generating a Web page based on the call record, the call record remotely accessible by the called party using a Web browser configured to access the Web page.

### BRIEF DESCRIPTION OF THE DRAWINGS

FIG. 1 is a block diagram of a call handling system, which incorporates various aspects of the present invention.

FIG. 2 is a flowchart of a method for call handling, in accordance with aspects of the present invention.

### DETAILED DESCRIPTION

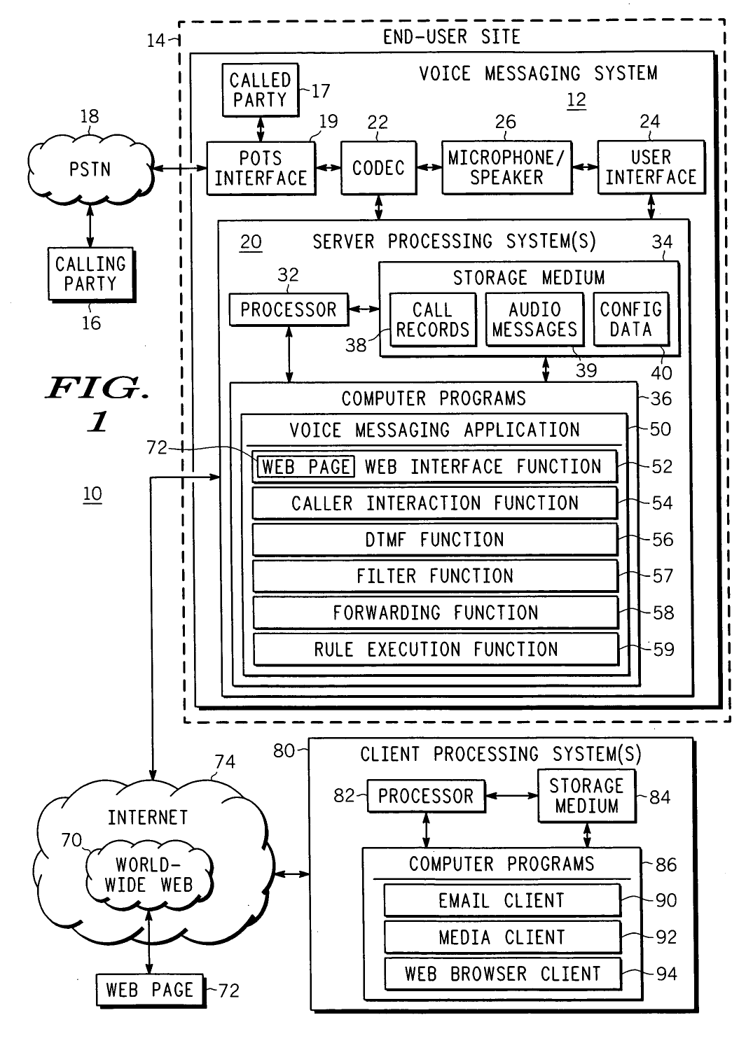

Turning now to the drawings, wherein like numerals designate like components, FIG. 1 is a block diagram of a call handling system 10. As shown, calls made by a calling party(ies) 16 via a public switched telephone network (“PSTN”) 18 are received by a called party(ies) 17 via a plain-old-telephone service (“POTS”) interface 19, such as a cordless telephone, at end-user site 14 associated with called party(ies) 17.

End-user site 14 includes a World Wide Web (“Web”)-based voice messaging system 12, which operates in accordance with aspects of the present invention to arrange for storage of call records 38 (discussed further below) and audio messages 39 (also discussed further below) associated with the calls made by calling party(ies) 16 to called party 17 and received by POTS interface 19, and to arrange for placing the call records and/or audio messages on the World Wide Web 70, at a location of a Web page 72 (discussed further below) at the end-user site or on the Internet 74. Information included in Web page 72 may be accessed remotely by the called party—using client processing system 80, for example.

Client processing system 80 includes a processor 82, which is responsive to a computer-readable storage medium 84 and to computer programs 86. Processor 82, storage medium 84, and computer programs 86 are well-known functions/components generally included in, or accessible by, many types of processor-based devices. As such, it will be appreciated that client processing system 80 may be implemented in a variety of ways—by a personal computer, for example, or by separate systems/components located within, or accessible by, other processor-based devices, such as personal digital assistants, telecommunication devices, and the like.

Computer-readable storage medium 84 operates to store, among other things, executable instructions, such as computer programs 86 (Email client 90, media client 92, and Web browser client 94 (all discussed further below)), which are loaded into a processor, such as processor 82, and executed.

Computer programs 86 are generally software components implemented according to well-known software engineering practices for component-based software development. Computer programs 86, however, may be any signal processing methods and/or stored instructions, in one or more parts, that electronically control or implement the functions discussed herein.

Email client 90 (such as Microsoft Outlook), media client 92 (such as Microsoft Media Player), and Web browser client 94 (Such as Microsoft Internet Explorer or Netscape) represent aspects of the functional arrangement of various well-known computer programs 86 accessible by client processing system 80 that pertain to remote access of the information included in Web page 72 by voice messaging system 12 in accordance with aspects of the present invention.

An exemplary architecture of voice messaging system 12 includes a server processing system 20, which is arranged for communication with user interface 24 and coder-decoder (“CODEC”) 22.

User interface 24 may be any type of known or future device or technology, such as a remote control, mouse, microphone, keyboard, or display, that enables the exchange of information with an end-user of voice messaging system 12.

CODEC 22 is operative to receive audio information (such as voice messages) from POTS interface 22 and an end-user communication interface 26 (as shown, a microphone/speaker), and to use an encoding algorithm, such as an MP3 encoding algorithm and/or a compression algorithm, to generate encoded audio information, which is passed to server processing system 20. Internal components of CODEC 22, and operation thereof, are well known, and it will be appreciated that different commercially available CODECs may provide different efficiency, quality, and features. It will also be appreciated that CODEC 22 may be implemented by, or in conjunction with, elements of server processing system 20, such as computer programs 36 (discussed further below).

Server processing system 20 includes a processor 32, responsive to a computer-readable storage medium 34 and to computer programs 36. Processor 32, storage medium 34, and computer programs 36 are functions/components generally included in, or accessible by, many types of processor-based devices. As such, it will be appreciated that server processing system 20 may be implemented in a variety of ways—for example, centrally (by a web server, for example), or as separate systems/components located within, or accessible by, other devices at end-user site 14 (such as personal computers or gateways), or any combination thereof.

Computer-readable storage medium 34 may be any electrical, magnetic, or optical memory device or system, now known or later developed, capable of recording or storing data, and in particular may be, or may include, a read only memory (“ROM”), a flash memory, a random access memory (“RAM”), a hard disk drive, a database, any type of compact disk or digital videodisk, and/or magnetic tape. It will be appreciated that the type of memory device or system used may be dictated by the type of data to be stored, and that computer-readable storage medium may include more than one type of memory, located together or separately.

Computer-readable storage medium 34 operates to store, among other things: (1) information/data used by Voice Messaging Application 50 (discussed further below), such as call records 38 (discussed further below), audio messages 39 (discussed further below), and configuration data 40 (discussed further below); and (2) executable instructions, such as computer programs 36, which are loaded into a processor, such as processor 32, and executed.

Call records 38 are collections of information associated with individual calls from calling parties 16 received by POTS interface 19—information such as the time a call was received, the calling party's phone number, whether the call was answered by the called party, whether the calling party left a message, the duration of the call, and the like. Call records 38 are stored in storage medium 34 (in a database, for example).

Audio messages 39 include audio information received from calling parties 16 and/or microphone/speaker 26, which has been encoded and/or compressed by CODEC 22 using well-known methods and techniques. Audio information received from calling parties 16 may be associated with, appended to, or made part of, particular call records 38.

Configuration data 40 represents instructions and/or information (for example, user passwords, user access conditions, and user filter conditions) used in the operation and control of certain aspects of voice messaging system 12. Configuration data 40 may be predetermined, or may be received from user interface 24 or Web page 72.

Computer programs 36 and functions thereof are generally software components implemented according to well-known software engineering practices for component-based software development. Computer programs 36, however, may be any signal processing activity and/or stored instructions, in one or more parts, that electronically control or implement the functions discussed herein.

Voice Messaging Application block 50 represents aspects of the functional arrangement of various computer programs 36 accessible by server processing system 20 that pertain to the handling of calls received by called party 17 via plain-old-telephone service (“POTS”) interface 19 at end-user site 14, in accordance with aspects of the present invention. It will be understood that functions represented by block 50 that involve aspects of networking may operate at one or more of the seven vertical layers of the well known abstract model that defines internetworking (the “OSI Model”): layer 1, the Physical layer; layer 2, the Data Link Layer; layer 3, the Network Layer; layer 4, the Transport Layer; layer 5, the Session Layer; layer 6, the Presentation Layer; and layer 7, the Application layer.

In general, Voice Messaging Application 50 includes the following functions: a Web Interface function 52, a Caller Interaction function 54, a dual tone multi-frequency (“DTMF”) function 56, a Filter function 57, and a Forwarding function 58, communicating with each other via Rule Execution function 59. In the abstract, Rule Execution function 59 maintains multiple rules regarding operation of Voice Messaging Application 50/voice messaging system 12—a rule generally defines a function of Voice Messaging Application 50 to be invoked, based on a particular trigger. Triggers may be at least in part defined by configuration data 40.

Web Interface function 52 corresponds to a collection of activities relating to the provisioning and maintenance of Web page 72, and the remote control of all features of voice messaging system 12. For example, Web Interface function requests and receives call records 38 and/or audio messages 39 from storage medium 34, and provides client processing system 80 with access to the requested/received information via Web page 72. Web page 72 may be associated with a universal resource locator (“URL”), which includes the protocol of Web page 72 (HTTP or FTP, for example), the domain name and/or IP address of Web page 72, and additional path information. Web page 72 may be generated and uploaded to the World-Wide Web on the Internet, or hosted at end-user site 14.

Filter function 57 is invoked to apply filter conditions (associated with configuration data 40) to the call handling activities performed by Voice Messaging Application 50. Filter conditions refer to user-defined call handling rules, such as the use of particular methods (for example, email, paging, and short messaging service) for notifying a particular called party 17 of a received call and/or audio message, and/or the definition of call handling criteria based on the contents of fields of a call record (for example, the time a call was received, the calling party's phone number, whether the call was answered by the called party, whether the calling party left a message, the duration of the call, and the like).

Caller Interaction function 54 implements well-known technology that allows calling party 16 to input information to Voice Messaging Application 50. Caller Interaction function 54 is invoked to present calling party 16 with a plurality of options relating to the use of voice messaging system 12. Each option is generally assigned to one number on a telephone keypad. For example, calling party 16 may be asked if she wishes to send a notification message and to whom—a plurality of menu options, each associated with a particular number on the telephone keypad, may be presented to the calling party (for example, “press one to notify David,” “press two to notify Sharon;” then “press one to notify via email,” “press two to notify via pager,” and so on).

Upon receipt of a user selection, DTMF function 56, which processes DTMF signaling using well-known methods and techniques, may be invoked to interpret the calling party's selection. DTMF function 56 may also process DTMF signaling to interpret end-user input received via POTS interface 19 or user interface 24.

Forwarding function 58 is operable to access and transmit call records 38 (or parts thereof) and/or audio messages 39 to email addresses (via attachments to emails, for example, using well-known methods and techniques), short message service addresses, pager addresses, and the like. In one example, a key or keys may be designated on user interface 24 for one-touch recording (via microphone/speaker 26) and forwarding of an audio message to a predetermined email address. Forwarding function 58 is fully configurable based on user-specified filter conditions (received from Web page 72 or user interface 24) included in configuration data 40.

A POP3 email client function (not shown) and/or text-to-speech technology may also be included in Voice Messaging Application 50, for retrieving and reading email audibly—playing emails through microphone/speaker 26 or through POTS interface 19, for example.

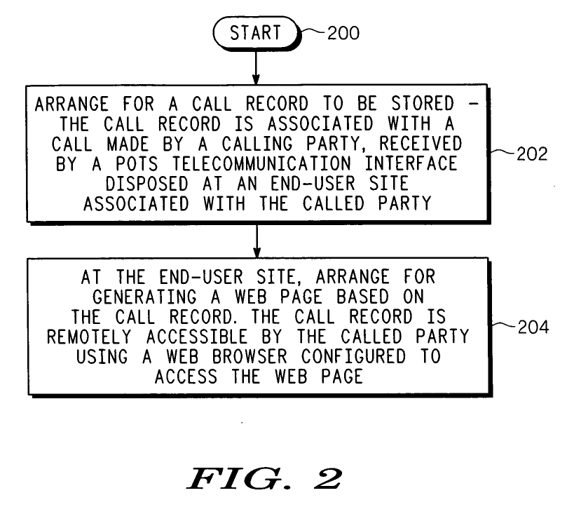

With continued reference to FIG. 1, FIG. 2 is a flowchart of a method for call handling, in accordance with various aspects of the present invention. The method may be implemented when one or more computer programs, such as computer programs 36 (for example, Voice Messaging Application 50 and functions/modules thereof), are loaded into a processor, such as processor 32, and executed.

The method begins at oval 200, and continues at block 202, where, at an end-user site associated with a called party (such as end-user site 14 associated with called party 17) it is arranged for a call record, such as call record 38, to be stored (in storage medium 34, for example). The call record is associated with a call made by a calling party (such as calling party 16) and received by a POTS telecommunication interface (such as POTS interface 19) disposed at the end-user site.

A call placed by calling party 16 is routed to called party 17 via PSTN 18 and is delivered to POTS interface 19. Voice Messaging Application creates a call record 38 associated with the call. The call record may include information such as the time the call was received, the calling party's phone number, whether the call was answered by the called party, whether the calling party left a message, the duration of the call, and the like. The call record may also include or reference an audio message, encoded and/or compressed by CODEC 22, left by the calling party. The call record and any audio message are stored on storage medium 34.

Forwarding function 58 may be invoked (in response to user-specified filter conditions implemented by Filter function 57 and/or calling party input received via Caller Interaction function 54 and processed by DTMF function 56) to transmit call records 38 (or parts thereof) and/or audio messages 39 to email addresses (via attachments to emails, for example, using well-known methods and techniques), short message service addresses, pager addresses, and the like. Next, at the end-user site, it is arranged, at block 204, for generating a Web page on the Internet based on the call record. The call record is remotely accessible by the called party using a Web browser configured to access the Web page.

Web Interface function 52 requests and receives call records 38 and/or audio messages 39 from storage medium 34, and provides client processing system 80 with access to the requested/received information via Web page 72. User-specified filter conditions implemented by Filter function 57 may be used to select call records 38 for display.

Call records 38 and/or audio messages 39 can be retrieved from any Web browser, such as web browser client 94 associated with client processing system 80, that is configured to access Web page 72 (The URL associated with Web page 72 may be input to Web browser client 94, for example). User-specified filter conditions implemented by Filter function 57 may be used to select call records 38 for display. Media client 92 may be used to play audio messages 39.

Aspects of the present invention described herein address the need for call handling methods and apparatuses that are co-located with, and configurable/controllable by, POTS users, and which allow POTS users to access call records and audio messages via a Web page.

It will be appreciated that aspects of the present invention are not limited to any specific embodiments of computer software or signal processing methods. For example, one or more processors and one or more computer programs packaged together or with other elements of Web-based voice messaging system 12 may implement functions described herein in a variety of ways. It will be understood that the functions described herein are processes that convey or transform data in a predictable way, and may generally be implemented in hardware, software, firmware, or any combination thereof.

When one element is indicated as being responsive to another element, the elements may be directly or indirectly coupled. Connections depicted herein may be logical or physical in practice to achieve a coupling or communicative interface between elements. Connections may be implemented as inter-process communications among software processes.

It will furthermore be apparent that other and further forms of the invention, and embodiments other than the specific embodiments described above, may be devised without departing from the spirit and scope of the appended claims, and it is therefore intended that the scope of this invention only be governed by the following claims.

1. A call handling apparatus, comprising:
a recording medium operative to store a call record associated with a call made by a calling party to a called party and received by a plain-old-telephone service (“POTS”) telecommunication interface disposed at an end-user site associated with the called party; and
a web server configured for use at the end-user site to receive the call record from the recording medium and to generate a World Wide Web (“Web”) page based on the call record,
wherein when the call record remotely accessible by the called party using a Web browser configured to access the Web page.

2. The call handling apparatus according to claim 1, wherein the Web page is operable to remotely control the call handling apparatus.

3. The call handling apparatus according to claim 2, wherein the end-user site comprises a home.

4. The call handling apparatus according to claim 2, wherein the web server comprises one of: a home gateway; and a personal computer.

5. The call handling apparatus according to claim 4, wherein the call record comprises one or more call characteristics selected from the group consisting of: time of receipt of the call; a phone number of the calling party; an answer status of the call; an audio message receipt status, and a duration of the call.

6. The call handling apparatus according to claim 4, further comprising:
a coder-decoder (“CODEC”) operative to receive one of a calling party audio message from the POTS telecommunication interface, and an end-user audio message from an end-user communication interface, and to use an encoding tool to form an encoded audio message therefrom, for storage in the recording medium.

7. The call handling apparatus according to claim 6, wherein the end-user communication interface comprises a microphone and a speaker.

8. The call handling apparatus according to claim 6, wherein the audio message receipt status is based on receipt of the calling party audio message.

9. The call handling apparatus according to claim 6, wherein the encoding tool comprises an MP3 algorithm, and wherein the encoded audio message comprises an MP3 file.

10. The call handling apparatus according to claim 6,
wherein the recording medium is operative to store the encoded audio message,
wherein the web server is configured to include the encoded audio message in the Web page, and
wherein when the encoded audio message is included in the Web page, the encoded audio message is remotely accessible using the Web browser configured to access the Web page.

11. A method for call handling, comprising:
at an end-user site associated with a called party, arranging for storage of a call record associated with a call made by a calling party to the called party and received by a POTS telecommunication interface disposed at the end-user site; and
at the end-user site, arranging for generating a Web page based on the call record, the call record remotely accessible by the called party using a Web browser configured to access the Web page.

12. The method for call handling according to claim 11, further comprising:
at the end-user site, arranging for storage of an audio message, the audio message comprising one of a calling party audio message received from the POTS telecommunications interface and associated with the call, and an end-user audio message received from an end-user communication interface disposed at the end-user site.

13. The method for call handling according to claim 12, further comprising:
arranging for encoding the audio message using an encoding tool, to form an encoded audio message.

14. The method for call handling according to claim 12, further comprising:
arranging for including the audio message on the Web page, the audio message remotely accessible using the Web browser configured to access the Web page.

15. The method for call handling according to claim 12, further comprising:
arranging for appending the audio message to an email; and
arranging for transmitting the email to an email address.

16. The method for call handling according to claim 11, further comprising:
presenting a plurality of notification options to the calling party via the POTS telecommunication interface, the plurality of notification options comprising methods for notifying the called party of the call, the methods selected from the group consisting of emailing, short-message-service, paging, call forwarding;
receiving the calling party's selection of a notification option from the plurality of notification options; and
handling the call based on the calling party's selection of the notification option.

17. The method for call handling according to claim 16, wherein the step of handling the call comprises sending the call record to the called party via the selected notification option.

18. A computer-readable medium encoded with a computer program which, when loaded into a processor, implements the method of claim 11.

19. A call handling apparatus, comprising:
a computer-readable storage medium configured to store a computer program; and
a processor responsive to the computer-readable storage medium and to the computer program, the computer program, when loaded into the processor and executed, operative to:
arrange for storage of a call record associated with a call made by a calling party to a called party and received by a POTS telecommunication interface disposed at an end-user site associated with the called party; and
at the end-user site, arrange for generating a Web page based on the call record, the call record remotely accessible by the called party using a Web browser configured to access the Web page.
